(19) United States
(12) Patent Application Publication
(10) Pub. No.: US 2023/0320371 A1
(43) Pub. Date: Oct. 12, 2023

(54) AN INTERESTERIFIED TRIGLYCERIDE COMPOSITION WITH A LOW AMOUNT OF DIGLYCERIDES

(71) Applicant: AAK AB (PUBL), Malmö (SE)

(72) Inventors: Bjarne JUUL, Højbjerg (DK); Anne BRINKØ, Viby J (DK)

(21) Appl. No.: 18/042,479

(22) PCT Filed: Aug. 26, 2021
(86) PCT No.: PCT/SE2021/050830

§ 371 Date: Feb. 22, 2023

(30) Foreign Application Priority Data
Aug. 31, 2020 (SE) 2051005-3

(51) Int. Cl. A23D 9/013; C11C 3/08; C11C 3/10; A23D 9/04; A23G 1/38; A23G 1/30; A21D 13/24; A21D 13/28

(52) U.S. Cl. CPC A23D 9/013; C11C 3/08; C11C 3/10; A23D 9/04; A23G 1/38; A23G 1/305; A21D 13/24; A21D 13/28

(57) ABSTRACT

The present invention relates to an interesterified triglyceride composition with an amount of diglycerides (DAG) of no more than 5% by weight. The invention also relates to use of the interesterified triglcyeride composition for manufacturing an oil mixture, an oil mixture, uses of the interesterified triglyceride composition or oil mixture in coating or enrobing for bakery, confectionary, and/or moulding applications, in fillings, such as bakery fillings and confectionary fillings and for chocolate or chocolate-like coating, an edible product comprising the interesterified triglyceride composition or the oil mixture, as well as a method of producing said interesterified triglyceride composition.

### TECHNICAL FIELD OF THE INVENTION

The present invention relates to an interesterified triglyceride composition with an amount of diglycerides (DAG) of no more than 5% by weight. The invention also relates to use of the interesterified triglyceride composition for manufacturing an oil mixture, an oil mixture, uses of the interesterified triglyceride composition or oil mixture in coating or enrobing for bakery, confectionery and/or moulding applications, in fillings, such as bakery fillings and confectionery fillings and for chocolate or chocolate-like coating, an edible product comprising the interesterified triglyceride composition or the oil mixture, as well as a method of producing said interesterified triglyceride composition.

### BACKGROUND OF THE INVENTION

An interesterified vegetable oil or mixture of different interesterified oils generally has an increased content of diglycerides (DAG) compared to the oil prior to interesterification. These DAG will remain unchanged after refining of the oil. The level of DAG can be significant and quite high in an interesterified oil. It is known that diglycerides (DAG) as a group inhibits nucleation, transition, and crystal growth in vegetable oils (Journal of the Science of Food and agriculture, 1 Apr. 1999, 79(5) 722-726)). The impact depends on concentration of the DAG, the fat composition and the type of DAG, but in most cases DAG will have a negative impact on crystallization speed, and, in many applications, a slow crystallization is a disadvantage.

Accordingly, the main object of the invention is to improve the crystallization behavior of an interesterified vegetable oil composition or mixture.

Yet another object is to provide a number of applications for such interesterified vegetable oil compositions or mixtures thereof.

### SUMMARY OF THE INVENTION

The present invention relates to an interesterified triglyceride composition with an amount of diglycerides (DAG) of no more than 5% by weight, such as no more than 4% by weight, such as no more than 3% by weight, such as no more than 2% by weight, such as no more than 1% by weight, such as no more than 0.5% by weight or such as no more than 0.2% by weight.

That DAG will have a negative impact on crystallization speed is demonstrated in the Examples by the reference fat shown in table 1; however, the interesterified triglyceride composition of the present invention shows a good crystallization behavior.

The present invention also relates to an oil mixture comprising an interesterified triglyceride composition according to the present disclosure in an amount of 50% to 99.5% by weight, such as 60% to 95% by weight, such as 70% to 95% by weight, such as 80% to 95% by weight, such as 85% to 90% by weight and at least one vegetable oil component.

Use of the interesterified triglyceride composition and the oil mixture in coating or enrobing for bakery, confectionary applications and/or moulding applications; or for chocolate or chocolate-like coating, or in fillings, such as bakery fillings and confectionary fillings is also disclosed herein.

The invention also relates to an edible product comprising the interesterified triglyceride composition or the oil mixture according to the present disclosure.

The present invention further relates to a method for production of an interesterified triglyceride composition, wherein the method comprises the steps of:
a) providing an interesterified oil composition and mixing said interesterified oil composition with a fatty acid mixture in a reaction container hereby obtaining an interesterified oil and fatty acid mixture blend;
b) heating the interesterified oil and fatty acid mixture blend under reduced pressure over a predefined period of time;
c) further increasing the temperature and heating the interesterified oil and fatty acid mixture blend over a predefined period of time, and simultaneously lowering the pressure further compared to step b);
d) keeping the interesterified oil and fatty acid mixture blend at the temperature and pressure of step c) for a predefined period of time;
e) optionally, removal of unreacted residue reactants from the resulting product of step d) by a distillation process;
f) optionally, bleaching, filtering, and/or deodorization of the resulting product of step d) or step e);
thereby obtaining said interesterified triglyceride composition.

### BRIEF DESCRIPTION OF DRAWINGS

FIG. 1 shows the heat of fusion from table 3 as function of cooling time below 21° C. for the three different CBR fat compositions; fat composition IV, V, and VI (table 2).

FIG. 2 shows the heat of fusion from table 6 as function of cooling time below 21° C. for the 3 different CBR fat compositions X, XI, and XII (table 5).

### DEFINITIONS

As used herein, the term “vegetable” shall be understood as originating from a plant or a single cell organism. Thus, vegetable fat or vegetable triglycerides are still to be understood as vegetable fat or vegetable triglycerides if all the fatty acids used to obtain said triglyceride or fat is of plant or single cell organism origin.

Saturated fatty acids are chains of carbon atoms joined by single bonds, with the maximum number of hydrogen atoms attached to each carbon atom in the chain. Unsaturated fatty acids are chains of carbon atoms joined by single bonds and varying numbers of double bonds, which do not have their full quota of hydrogen atoms attached. An unsaturated fatty acid can exist in two forms, the cis form and the trans form. A double bond may exhibit one of two possible configurations: trans or cis.

In trans configuration (a trans fatty acid), the carbon chain extends from opposite sides of the double bond, whereas, in cis configuration (a cis fatty acid), the carbon chain extends from the same side of the double bond.

By using the nomenclature CX means that the fatty acid comprises X carbon atoms, e.g. a C14 fatty acid has 14 carbon atoms while a C8 fatty acid has 8 carbon atoms.

By using the nomenclature CX:Y means that the fatty acid comprises X carbon atoms and Y double bonds, e.g. a C14:0 fatty acid has 14 carbon atoms and 0 double bonds while a C18:1 fatty acid has 18 carbon atoms and 1 double bond.

By vegetable oil component is meant a vegetable fat or oil originating from a plant or a single cell organism. The vegetable fat or oil component can e.g. be selected from the group of palm kernel oil, coconut oil, high lauric rapeseed oil and/or fractions thereof. The vegetable fat or oil component can be an interesterified, fractionated and/or hydrogenated version thereof.

As used herein, “%” or “percentage” relates to weight percentage i.e. wt. % or wt.-% if nothing else is indicated.

As used herein, “oil” and “fat” are used interchangeably, unless otherwise specified.

As used herein, “vegetable oil” and “vegetable fat” are used interchangeably, unless otherwise specified.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

As used herein “cocoa butter replacer”, CBR, is intended to mean an edible fat having a triglyceride composition significantly different to cocoa butter. Cocoa butter replacers can have from high to low and even no trans fatty acids in its triglyceride composition. Cocoa butter replacers are only mixable with cocoa butter in medium to small ratios. Furthermore, in contrast to chocolate, cocoa butter replacer based compounds do not need to undergo a treatment at different temperatures, known as tempering, prior to moulding, coating, or enrobing, in order to obtain a final product with acceptable shelf life.

As used herein “edible” is something that is suitable for use as food or as part of a food product, such as a dairy or confectionary product.

For products and methods in the confectionery areas, reference is made to “Chocolate, Cocoa and Confectionery”, B. W. Minifie, Aspen Publishers Inc., 3. Edition 1999.

A food product is a product for human consumption. A specific group of products intended to be covered is those where cocoa butter and cocoa butter-like fats are used.

By a chocolate or chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like product may be produced with a low amount of or even without cocoa butter, e.g. by replacing the cocoa butter with a cocoa butter equivalent, cocoa butter substitute, etc. In addition, many chocolate or chocolate-like products comprise cocoa powder or cocoa mass, although some chocolate or chocolate-like products, such as typical white chocolates, may be produced without cocoa powder, but e.g. drawing its chocolate taste from cocoa butter. Depending on the country and/or region there may be various restrictions on which products may be marketed as chocolate.

As used herein “residue reactants” is to be interpreted as any free fatty acids, monoglycerides, glycerol and water that have not reacted in a given reaction and hence are left in the reaction mixture as unwanted residue reactants together with the final product.

The term “comprising” or “to comprise” is to be interpreted as specifying the presence of the stated parts, steps, features, or components, but does not exclude the presence of one of more additional parts, steps, features, or components.

As used herein, the term “and/or” is intended to mean the combined (“and”) and the exclusive (“or”) use, i.e. “A and/or B” is intended to mean “A alone, or B alone, or A and B together”.

Solid fat content (SFC) is a measure of the percentage of fat in crystalline (solid) phase to total fat (the remainder being in liquid phase) across a temperature gradient.

### DETAILED DESCRIPTION OF THE INVENTION

When describing the below embodiments, the present invention envisages all possible combinations and permutations of the below described embodiments with the above disclosed aspects.

The invention relates to an interesterified triglyceride composition with an amount of diglycerides (DAG) of no more than 5% by weight, such as no more than 4% by weight, such as no more than 3% by weight, such as no more than 2% by weight, such as no more than 1% by weight, such as no more than 0.5% by weight or such as no more than 0.2% by weight.

The interesterified triglyceride composition of the present invention shows a good crystallization behavior compared to other interesterified triglyceride compositions. This is due to the low amount of DAG in the interesterified triglyceride composition. It is commonly known that interesterification creates DAG, and that DAG slows down crystallization speed and, in many applications, a slow crystallization is a disadvantage.

This invention demonstrates how it is possible to reduce the amount of DAG by esterification of a mixture of fatty acids and an interesterified oil composition, and thereby improve the crystallization behaviour significant for the produced triglyceride composition alone as well as in a final product which e.g. can be a chocolate like compound or a filling, where the DAG reduced interesterified triglyceride compositions is a part of.

In one or more embodiments, the amount of DAG is no more than 3.0% by weight, such as no more than 2.8% by weight, such as no more than 2.6% by weight, such as no more than 2.4% by weight, such as no more than 2.2% by weight, such as no more than 2.0% by weight, such as no more than 1.8% by weight, such as no more than 1.5% by weight, such as no more than 1.2% by weight, such as no more than 1.0% by weight, such as no more than 0.5% by weight, or such as no more than 0.2% by weight.

In one or more embodiments, the amount of DAG is in the range of 0.2% to 5% by weight, such as in the range of 0.5% to 4% by weight, such as in the range of 0.5% to 3% by weight, such as in the range of 0.5% to 2% by weight, or such as in the range of 0.5% to 1.5% by weight.

In one or more embodiments, the amount of DAG is in the range of 0.5% to 5% by weight, such as in the range of 1% to 4% by weight, such as in the range of 1% to 3% by weight, such as in the range of 1% to 2.5% by weight, or such as in the range of 1.2% to 2.5% by weight.

In one or more embodiments, the amount of DAG is in the range of 0.2% to 3% by weight, such as in the range of 0.2% to 2.6% by weight, or such as in the range of 0.2% to 2.4% by weight.

In one or more embodiments, the interesterified triglyceride composition is a vegetable interesterified triglyceride composition. The interesterified triglyceride composition originates from a vegetable fat composition prior to being interesterified. In one or more embodiments, the interesterified triglyceride composition is not originating from a single cell organism.

In one or more embodiments, the interesterified triglyceride composition is a chemically interesterified triglyceride composition. In one or more embodiments, the interesterified triglyceride composition is an enzymatically interesterified triglyceride composition.

In one or more embodiments, the sum of saturated C8, C10, C12, and C14 fatty acids is at least 0.75% by weight, such as at least 1% by weight, such as at least 1.25% by weight, or such as at least 1.5% by weight. In one or more embodiments, the sum of saturated C8, C10, C12 and C14 fatty acids is in the range of 0.75% to 20% by weight, such as in the range of 1% to 15% by weight, such as in the range of 1% to 10% by weight, or such as in the range of 1% to 7.5% by weight.

In one or more embodiments, the sum of saturated C12 and C14 fatty acids is at least 0.75% by weight, such as at least 1% by weight, such as at least 1.25% by weight, or such as at least 1.5% by weight. In one or more embodiments, the sum of saturated C12 and C14 fatty acids is in the range of 0.75% to 20% by weight, such as in the range of 1% to 15% by weight, such as in the range of 1% to 10% by weight, or such as in the range of 1% to 7.5% by weight.

In one or more embodiments, the amount of myristic acid (C14:0) is at least 0.75% by weight, such as at least 1% by weight, such as at least 1.25% by weight, or such as at least 1.5% by weight. In one or more embodiments, the amount of myristic acid is in the range of 0.75% to 20% by weight, such as in the range of 1% to 15% by weight, such as in the range of 1% to 10% by weight, or such as in the range of 1% to 7.5% by weight.

In one or more embodiments, the amount of lauric acid (C12:0) is in the range of 0% to 5% by weight, such as in the range of 0.75% to 5% by weight, such as in the range of 1% to 5% by weight, or such as in the range of 1% to 4% by weight.

In one or more embodiments, in the interesterified triglyceride composition:
the amount of DAG is no more than 3.0% by weight; and
the sum of saturated C8, C10, C12 and C14 fatty acids is at least 0.75% by weight, such as at least 1% by weight, such as at least 1.25% by weight, or such as at least 1.5% by weight.

In one or more embodiments, in the interesterified triglyceride composition:
the amount of DAG is no more than 2.6% by weight; and
the sum of saturated C8, C10, C12 and C14 fatty acids is at least 0.75% by weight, such as at least 1% by weight, such as at least 1.25% by weight, or such as at least 1.5% by weight.

In one or more embodiments, in the interesterified triglyceride composition:
the amount of DAG is no more than 2.4% by weight; and
the sum of saturated C8, C10, C12 and C14 fatty acids is at least 0.75% by weight, such as at least 1% by weight, such as at least 1.25% by weight, or such as at least 1.5% by weight.

In one or more embodiments, in the interesterified triglyceride composition:
the amount of DAG is no more than 3.0% by weight; and
the amount of myristic acid is at least 0.75% by weight, such as at least 1% by weight, such as at least 1.25% by weight, or such as at least 1.5% by weight.

In one or more embodiments, in the interesterified triglyceride composition:
the amount of DAG is no more than 2.6% by weight; and
the amount of myristic acid is at least 0.75% by weight, such as at least 1% by weight, such as at least 1.25% by weight, or such as at least 1.5% by weight.

In one or more embodiments, in the interesterified triglyceride composition:
the amount of DAG is no more than 2.4% by weight; and
the amount of myristic acid is at least 0.75% by weight, such as at least 1% by weight, such as at least 1.25% by weight, or such as at least 1.5% by weight.

In one or more embodiments, in the interesterified triglyceride composition:
the amount of DAG is in the range of 0.2% to 3.0% by weight; and
the sum of saturated C8, C10, C12 and C14 fatty acids is in the range of 0.75% to 20% by weight, such as in the range of 1% to 15% by weight, such as in the range of 1% to 10% by weight, or such as in the range of 1% to 7.5% by weight.

In one or more embodiments, in the interesterified triglyceride composition:
the amount of DAG is in the range of 0.2% to 2.6% by weight; and
the sum of saturated C8, C10, C12 and C14 fatty acids is in the range of 0.75% to 20% by weight, such as in the range of 1% to 15% by weight, such as in the range of 1% to 10% by weight, or such as in the range of 1% to 7.5% by weight.

In one or more embodiments, in the interesterified triglyceride composition:
the amount of DAG is in the range of 0.2% to 2.4% by weight; and
the sum of saturated C8, C10, C12 and C14 fatty acids is in the range of 0.75% to 20% by weight, such as in the range of 1% to 15% by weight, such as in the range of 1% to 10% by weight, or such as in the range of 1% to 7.5% by weight.

In one or more embodiments, in the interesterified triglyceride composition:
the amount of DAG is in the range of 0.2% to 3.0% by weight; and
the amount of myristic acid is the range of 0.75% to 20% by weight, such as in the range of 1% to 15% by weight, such as in the range of 1% to 10% by weight, or such as in the range of 1% to 7.5% by weight.

In one or more embodiments, in the interesterified triglyceride composition:
the amount of DAG is in the range of 0.2% to 2.6% by weight; and
the amount of myristic acid is the range of 0.75% to 20% by weight, such as in the range of 1% to 15% by weight, such as in the range of 1% to 10% by weight, or such as in the range of 1% to 7.5% by weight.

In one or more embodiments, in the interesterified triglyceride composition:
the amount of DAG is in the range of 0.2% to 2.4% by weight; and
the amount of myristic acid is the range of 0.75% to 20% by weight, such as in the range of 1% to 15% by weight, such as in the range of 1% to 10% by weight, or such as in the range of 1% to 7.5% by weight.

In one or more embodiment, the interesterified triglyceride composition is a non-hydrogenated vegetable fat composition. An advantage of the present interesterified triglyceride composition is that it can be labelled as non-hydrogenated. The interesterified triglyceride composition is a “consumer friendly” product as hydrogenation is typically undesired by consumers and may require additional labelling of the product in some regions or countries.

Hydrogenation is a process where unsaturated fatty acids are made partially saturated. Non-hydrogenated means not hydrogenated or un-hydrogenated. By subjecting unsaturated fatty acids to a process of hydrogenation (e.g. involving a combination of catalysts, hydrogen, and heat), the double bond opens, and hydrogen atoms bind to the carbon atoms, hereby saturating the double bond. While most of the unsaturated oil will either remain as was (on its double bond structure) or be converted to the corresponding saturated fatty acid, some of the double bonds may open during the hydrogenation process and then re-close in another double bond configuration, hereby converting a cis fatty acid to a trans fatty acid or vice versa. A non-hydrogenated vegetable fat composition is a composition comprising only non-hydrogenated triglycerides, meaning that at no point in the process, are the triglycerides subjected to hydrogenation.

The invention also relates to use of an interesterified triglyceride composition for manufacturing of an oil mixture, wherein the oil mixture comprises a blend of an interesterified triglyceride composition selected from an interesterified triglyceride composition according to the above disclosure and at least one vegetable oil component. In one or more embodiments, the at least one vegetable fat component is selected from the group consisting of palm kernel oil, coconut oil, shea oil, high lauric rapeseed oil, and/or fractions thereof or an interesterified, fractionated, and/or hydrogenated version of palm kernel oil, coconut oil, shea oil, high lauric rapeseed oil, and/or fractions thereof. In one or more embodiments, the obtained oil mixture comprises from 50% to 99.5% by weight of the interesterified triglyceride composition, such as 60% to 95% by weight, such as 70% to 95% by weight, such as 80% to 95% by weight, or such as 85% to 90% by weight.

In one or more embodiments, the at least one vegetable fat component is selected from the group consisting of palm stearin, palm kernel stearin, coconut oil, shea oil, or fractions thereof or hydrogenated versions thereof.

The present disclosure also comprise an oil mixture comprising an interesterified triglyceride composition according to the above disclosure in an amount of 50% to 99.5% by weight, such as 60% to 95% by weight, such as 70% to 95% by weight, such as 80% to 95% by weight, or such as 85% to 90% by weight and at least one vegetable oil component. In one or more embodiments, the at least one vegetable oil component is selected from the group consisting of palm kernel oil, coconut oil, shea oil, high lauric rapeseed oil, and/or fractions thereof or an interesterified, fractionated, and/or hydrogenated version of palm kernel oil, coconut oil, shea oil, high lauric rapeseed oil, and/or fractions thereof. In one or more embodiments, the at least one vegetable fat component is selected from the group consisting of palm stearin, palm kernel stearin, coconut oil, shea oil, or fractions thereof or hydrogenated versions thereof.

Also disclosed herein is the use of the interesterified triglyceride composition according to the present disclosure or the oil mixture according to the present disclosure in coating or enrobing for bakery, confectionery, and/or moulding applications.

Also disclosed herein is the use of the interesterified triglyceride composition according to the present disclosure or the oil mixture according to the present disclosure in fillings, such as bakery fillings and confectionery fillings.

Also disclosed herein is the use of the interesterified triglyceride composition according to the present disclosure or the oil mixture according to the present disclosure for chocolate and chocolate-like coatings.

The present invention also discloses an edible product comprising the interesterified triglyceride composition according to the present disclosure or the oil mixture according to the present disclosure.

In one or more embodiments of the edible product, the interesterified triglyceride composition or the oil mixture makes up from 50% to 100% by weight, such as from 80% to 100% by weight, such as from 90% to 100% by weight, or such as around 95% by weight of the total fat phase in the edible product.

In one or more embodiment of the edible product, the interesterified triglyceride composition or the oil mixture makes up from 10% to 70% by weight, such as from 20% to 60% by weight, such as from 25% to 50% by weight, or such as from 28% to 40% by weight of the total edible product.

The edible product may be a bakery product, a dairy product, a chocolate product, and/or a chocolate-like product. The edible product may be a coating or enrobing product for bakery, confectionery, and/or moulding applications. The edible product may be a filling, such as a bakery filling or a confectionery filling. The edible product may be a chocolate or chocolate-like coating.

The present invention also disclose a method for production of an interesterified triglyceride composition according to the present disclosure, wherein the method comprises the steps of:
a) providing an interesterified oil composition and mixing said interesterified oil composition with a fatty acid mixture in a reaction container hereby obtaining an interesterified oil and fatty acid mixture blend;
b) heating the interesterified oil and fatty acid mixture blend under reduced pressure over a predefined period of time;
c) further increasing the temperature and heating the interesterified oil and fatty acid mixture blend over a predefined period of time, and simultaneously lowering the pressure further compared to step b);
d) keeping the interesterified oil and fatty acid mixture blend at the temperature and pressure of step c) for a predefined period of time;
e) optionally, removal of unreacted residue reactants from the resulting product of step d) by a distillation process;
f) optionally, bleaching, filtering, and/or deodorization of the resulting product of step d) or step e);
   thereby obtaining said interesterified triglyceride composition.

The steps a) to f) are in one embodiment sequentially in that order, hence step a) before step b) and so forth.

The present method enables the production of an interesterified triglyceride composition with an amount of diglycerides (DAG) of no more than 5% by weight that shows good crystallization behavior compared to other interesterified triglyceride compositions.

By choosing different specific fatty acids, it is possible to optimize an interesterified triglyceride composition in different directions, since different fatty acids will impact the behaviour of the interesterified triglyceride composition such as crystallization, melting properties, and hardness differently.

The present invention solves the problem of eliminating the DAG in an interesterified triglyceride composition by adding fatty acids to an interesterified oil product and subjecting this mixture to an esterification, optionally followed by removal of unreacted residue reactants by distillation. The DAG level is lowered by converting them into triglycerides (TAGs), which can be seen from the examples disclosed herein.

In one or more embodiments, the amount of fatty acid mixture to be mixed with the interesterified oil composition is in the range of 0.05 mol to 1.0 mol fatty acid mixture per mol interesterified oil composition, such as 0.08 mol to 0.9 mol, such as 0.2 mol to 0.7 mol, such as 0.52 mol to 0.5 mol, such as 0.5 mol to 0.9 mol fatty acid mixture per mol interesterified oil composition. This means that for every mol of interesterified oil composition at least 0.05 mol of fatty acid mixture is used.

In principal, any fatty acid can be added, but in an embodiment, specific fatty acids are used. In one embodiment 20% to 80% myristic acid and 20% to 80% oleic acid is used. As can be seen in the examples this improves the crystallization speed significantly.

In one embodiment, 100% lauric acid is used. In another embodiment 20% to 80% palmitic acid, 8% to 50% stearic acid, and 20% to 80% oleic acid is used. In another embodiment 100% oleic acid is used. As can be seen in the examples these embodiments also shows an improved crystallization speed.

The interesterified oil composition used in step a) is the starting oil which has a high amount of DAG. In one or more embodiment the amount of DAG in the interesterified oil composition is at least 6% by weight, such as at least 7.5% by weight, or such as at least 10% by weight.

In one or more embodiments of the method, the interesterified oil composition comprises lauric acid in amounts of no more than 1% by weight, such as no more than 0.5% by weight, such as no more than 0.2% by weight, or such as no more than 0.1% by weight.

In one or more embodiments of the method, the interesterified oil composition comprises myristic acid in amounts of no more than 20% by weight, such as no more than 15% by weight, such as no more than 10% by weight, or such as no more than 5% by weight.

In one or more embodiments of the method, none of the triglycerides in the interesterified triglyceride composition is at any time in the process subjected to hydrogenation.

The fatty acid mixture used in step a) can in one embodiment comprise both hydrogenated and non-hydrogenated free fatty acids.

A reaction container may be any container suitable for carrying out a chemical reaction. Such containers may e.g. be, but not limited to, a flask, a tank, a tube, an Erlenmeyer flask, a laboratory flask, a round-bottom flask, a three-necked flask, a two-necked flask, a one-necked flask, a glass flask, or a metal flask. The reaction may be carried out with or without agitation (e.g. stirring).

In one or more embodiments of the method, a condenser is used. The condenser is heated to a temperature of 40° C. to 150° C., such as 50° C. to 90° C. such as 65° C. to 90° C. This temperature of the condenser is dependent on the size and surface area of the condenser. A person skilled in the art would know how to adjust this.

In one or more embodiment of the method, the interesterified oil and fatty acid mixture blend is heated to a temperature in the range of 140° C. to 180° C. in step b). In one or more embodiments of the method, the interesterified oil and fatty acid mixture blend is heated to a temperature of at least 140° C. in step b). In one or more embodiments of the method, the interesterified oil and fatty acid mixture blend is heated to a temperature in the range of 140° C. to 150° C. in step b).

In one or more embodiments of the method, the reduced pressure in step b) is in the range of 150 to 400 mbar, such as in the range of 175 to 250 mbar.

In one or more embodiments of the method, the predefined period of time in step b) is in the range of 10 minutes to 2 hours, such as in the range of 10 minutes to 1 hour, such as in the range of 15 minutes to 45 minutes, or such as in the range of 15 minutes to 30 minutes.

In one example, the time needed for the step of heating the reaction to between 140° C. and 180° C. in step b) will depend on the equipment used.

In one or more embodiments of the method, the predefined period of time in step b) is at least 10 minutes, such as at least 15 minutes, or such as at least 20 minutes.

In one or more embodiments of the method, the temperature in step c) is in the range of 180° C. to 250° C., such as in the range of 200° C. to 230° C.

In one or more embodiments of the method, the interesterified oil and fatty acid mixture blend in step c) is heated to at least 160° C.

In one or more embodiments of the method, the interesterified oil and fatty acid mixture blend in step c) is heated to maximum 230° C. In one or more embodiments of the method, the interesterified oil and fatty acid mixture blend in step c) is heated to maximum 240° C.

The temperature is gradually raised when going from step b) to step c). In one or more embodiments of the method, the temperature is raised from around 150° C. in step b) and up to around 210° C. in step c).

In one or more embodiments of the method, the pressure in step c) is in the range of 10 mbar to mbar, such as in the range of 20 mbar to 250 mbar, such as in the range of 30 mbar to 150 mbar, such as in the range of 30 mbar to 90 mbar, or such as in the range of 30 mbar to 40 mbar.

The pressure is gradually decreased when going from step b) to step c). In one or more embodiments of the method, the pressure is decreased from around 200 mbar in step b) and down to around 30 mbar in step c).

In one or more embodiments of the method, the predefined period of time in step c) is in the range of 15 minutes to 3 hours, such as in the range of 15 minutes to 2 hours, such as in the range of 30 minutes to 1 hours.

In one or more embodiments of the method, the predefined period of time in step c) is at least 15 minutes, such as at least 20 minutes, or such as at least 30 minutes.

In one or more embodiments of the method, step b) and step c) are combined into one step by continuously heating the interesterified oil and fatty acid mixture blend to the wanted temperature under reduced pressure over a predefined time.

In one or more embodiments of the method, where step b) and step c) are combined into one step by continuously heating the interesterified oil and fatty acid mixture blend to the wanted temperature under reduced pressure over a predefined time, the temperature is in the range of 180° C. to 250° C., such as in the range of 200° C. to 230° C. In one or more embodiments, the glycerol and fatty acid mixture blend is heated to maximum 230° C. In one or more embodiments, the glycerol and fatty acid mixture blend is heated to maximum 240° C. In one or more embodiment, the pressure is in the range of 10 mbar to 400 mbar, such as in the range of 20 mbar to 250 mbar, such as in the range of 30 mbar to 150 mbar, such as in the range of 30 mbar to 90 mbar, or such as in the range of 30 mbar to 40 mbar. In one or more embodiment the predefined period of time is in the range of 15 minutes to 3 hours, such as in the range of 15 minutes to 2 hours, such as in the range of 30 minutes to 2 hours. In one or more embodiment, the predefined period of time is at least 15 minutes, such as at least 20 minutes, such as at least 30 minutes, or such as at least 1 hour.

In one or more embodiments of the method, step c) comprises two steps; c1) lowering the pressure compared to step b) over a predefined period of time; c2) increasing the temperature under the reduced pressure of step c1) over a predefined period of time.

In one or more embodiments of the method, step c1) and step c2) are sequentially in that order. In another embodiment of the method, step c1) and step c2) are reversed.

In one or more embodiments, the pressure in step c1) is in the range of 10 mbar to 400 mbar, such as in the range of 20 mbar to 250 mbar, such as in the range of 30 mbar to 150 mbar, such as in the range of 30 mbar to 90 mbar, or such as in the range of 30 mbar to 40 mbar. In one or more embodiments, the temperature in step c) is in the range of 180° C. to 250° C., such as in the range of 200° C. to 230° C. In one or more embodiments, the interesterified oil and fatty acid mixture blend in step c2) is heated to at least 160° C. In one or more embodiments, the interesterified oil and fatty acid mixture blend in step c2) is heated to maximum 230° C. In one or more embodiments, the interesterified oil and fatty acid mixture blend in step c2) is heated to maximum 240° C. In one or more embodiment, the predefined period of time in step c1) is in the range of 15 minutes to 3 hours, such as in the range of 15 minutes to 2 hours, or such as in the range of 15 minutes to 1 hour. In one or more embodiments, the predefined period of time in step c2) is in the range 15 minutes to 3 hours, such as in the range of 15 minutes to 2 hours, or such as in the range of 15 minutes to 1 hour.

In one example, the time needed for the step of heating the reaction from between 140° C. and 180° C. up to between 200° C. and 230° C. will depend on the equipment used.

In one or more embodiments of the method, the predefined period of time in step d) is in the range of 5 hours to 20 hours, such as in the range of 5 hours to 15 hours, or such as in the range of 8 hours to 12 hours.

In one or more embodiments of the method, the full method is completed in less than 24 hours, such as less than 20 hours, such as less than 15 hours, or such as less than 12 hours.

The skilled person will know that the appropriate reaction depends on both the chosen reaction temperature and excess of fatty acid mixture used. If the reaction temperature is increased, the reaction time will be shorter, and likewise if a lower reaction temperature is chosen the reaction time will be longer. If a larger excess of fatty acid mixture is used the reaction time will be shorter, and likewise, if a smaller excess of fatty acid mixture is used the reaction time will be longer. If both a high temperature and a high excess of fatty acid mixture are used, the reaction time will also be shorter.

In one or more embodiments, the method is done without application of a catalyst.

A standard re-esterification process uses a catalyst, and thus one of the advantages of the present process is that it can be done without catalyst in reasonable time and with reasonable yield. Since the process does not need a catalyst there is no need for extra processing steps to remove the catalyst after the reaction which makes the overall process simple and easy to handle.

In one or more embodiments of the present method, a catalyst is added in step a). The addition of a catalyst may increase reaction speed and hence reduce the overall reaction time needed to obtain the interesterified triglyceride composition. The catalyst can be any catalyst known to be beneficial in an esterification process and particularly preferred is the use of zinc oxide as a catalyst. Hence, in one or more embodiments of the present method, zinc oxide (ZnO) is added in step a) as a catalyst.

It is known to the person skilled in the art that the predefined amount of time in step d) needed for obtaining a fat composition will decrease if a catalyst is used.

It is well within the skills of the skilled person to determine the amount of catalyst needed in the process. In one or more embodiments of the present method, that amount of catalyst added is at least 0.8∠, such as at least 0.9∠, or such as 1.0∠. The skilled person will also know that a higher amount of catalyst can be added, which will lead to a faster reaction time, however there is a natural upper limit of how much catalyst there should be added. In one or more embodiments of the present method, no more than 2% catalyst is added, such as no more that 1%, or such as no more than 0.5%.

In one or more embodiments of the method, the distillation in step e) is a physical refinement. In one or more embodiments of the method, the distillation in step e) takes place at a temperature of at least 160° C., and optionally under reduced pressure. In one or more embodiments of the method, the distillation takes place at a temperature of at least 190° C., and under reduced pressure. In one or more embodiments of the method, the distillation takes place at a temperature of between 220° C. and 260° C., and under reduced pressure, such as around 240° C., and under reduced pressure. This is standard conditions for a distillation process as known by the person skilled in the art. In one embodiment, chemical refinement can be used instead of physical refinement and the skilled person will then know to change the temperature to around 100° C. In one embodiment, chemical refinement could be conducted by mixing lye, water, and the interesterified oil and fatty acid mixture blend at 100° C. after which the interesterified oil and fatty acid mixture blend is washed with water to remove residue reactants.

In one or more embodiments, the unreacted (excess) residue reactants are primarily excess free fatty acids.

In one or more embodiments, the unreacted residue reactants or the excess free fatty acids removed after physical or chemical refinement can be recycled and reused in a new batch of the present process, which will lower the cost of the overall process and minimize side stream waste.

When describing the embodiments, the combinations and permutations of all possible embodiments have not been explicitly described. Nevertheless, the mere fact that certain measures are recited in mutually different dependent claims or described in different embodiments does not indicate that a combination of these measures cannot be used to advantage. The present invention envisage all possible combinations and permutations of the described embodiments.

The present invention is further illustrated by the following examples, which are not to be construed as limiting the scope of protection.

### EXAMPLES

### Example 1—Esterification of an Interesterified Oil Composition with Oleic Acid or Myristic Acid and Oleic Acid

Esterification of an Interesterified Oil Composition with Oleic Acid

1 kg interesterified oil composition (mid fraction (MF) oil blend, 1.18 mol based on an average triglyceride molar mass of 850 g/mol) and 248 g oleic acid (0.88 mol) were mixed in a reaction vessel equipped with a vacuum inlet, a cold trap, and a condenser heated to 70° C. The reaction mixture was heated to 150° C. over app. 20 minutes under reduced pressure of 200 mbar. The temperature was gradually raised to 210° C. while the pressure was gradually lowered to 33 mbar over a 30 to 60 minutes period. Once the final reaction temperature was reached, the reaction mixture was left at these conditions for app. 10 hours. In this example, the crude oil obtained was distilled at 240° C. under reduced pressure to remove excess free fatty acids before being bleached and deodorized to yield the final product.

Esterification of an Interesterified Oil Composition with Myristic Acid and Oleic Acid

2 kg interesterified fat (MF oil blend, 2.35 mol based on an average triglyceride molar mass of 850 g/mol), 295 g oleic acid (0.88 mol) and 200 g myristic acid (0.88 mol) were mixed in a reaction vessel equipped with a vacuum inlet, a cold trap, and a condenser heated to 70° C. The reaction mixture was heated to 150° C. over app. 20 minutes under reduced pressure of 200 mbar. The temperature was gradually raised to 210° C. while the pressure was gradually lowered to 33 mbar over a 30 to 60 minutes period. Once the final reaction temperature was reached, the reaction mixture was left at these conditions for app. 10 hours. In this example, the crude oil obtained was distilled at 240° C. under reduced pressure to remove excess free fatty acids before being bleached and deodorized to yield the final product.

Table 1 shows three vegetable fat compositions:
I. Is a chemical interesterified fractionated fat composition which is bleached and deodorized. This is the reference fat composition with a relatively high DAG content, corresponding to an average amount present in an interesterified fat composition.
II. Is fat composition I esterified with a 50/50 mixture of myristic acid and oleic acid to reduce the DAG content.
III. Is fat composition I esterified with oleic acid to reduce the DAG content.

TABLE 1

| | Fat composition | | |
|---|---|---|---|
| | I Reference | II Fat | III Fat |
| | Bleached, | composition I | composition |
| | deodorized, | esterified with | I esterified |
| | interesterified | myristic acid | with oleic |
| | fat composition | and oleic acid | acid |
| Σ U₃ #1 | 1.8 | 2.2 | 2.5 |
| Σ SatU₂ #1 | 10.5 | 13.8 | 19.8 |
| Σ Sat₂U #1 | 75.3 | 69.2 | 65.7 |
| Σ Sat₃ | 12.4 | 14.8 | 12.0 |
| Mono-glyceride #2 | <0.1 | <0.1 | <0.1 |
| Di-glycerides #2 | 11.4 | 2.2 | 2.4 |
| Tri glycerides #2 | 86.4 | 94.5 | 94.7 |
| Solid fat content | 79.5 | 80.5 | 75.6 |
| 20° C. #3 | | | |
| Solid fat content | 63.7 | 57.0 | 49.7 |
| 25° C. #3 | | | |
| Solid fat content | 34.6 | 38.0 | 30.0 |
| 30° C. #3 | | | |
| Solid fat content | 17.9 | 19.9 | 14.8 |
| 35° C. #3 | | | |
| C14:0 myristic | 0.8 | 3.9 | 1.0 |
| acid #4 | | | |

#1 AOCS Ce 5b-89
#2 AOCS Cd 22-91
#3 IUPAC 2.150a (serial)
#4 IUPAC 2.304

The different solid fat content in Table 1 shows how it is possible to change the hardness and melting properties by subjecting a mixture of fatty acids and an interesterified fat composition to esterification.

### Example 2—Fat Mixtures of Fat Composition I, II, and Ill and an Interesterified Mixture of 30% Palm Stearin IV 34+70% Palm Kernel Stearin IV 7

Fat composition I to III is used as the major component (88%) in three fat compositions shown in table 2. Fat composition IV to VI are fat compositions which can be used as cocoa butter replacers (CBRs) in chocolate like compounds for coating and moulding applications as well as for filling applications.

TABLE 2

| | Fat composition | | |
|---|---|---|---|
| | IV Reference | V | VI |
| | Cocoa butter replacer | Cocoa butter replacer | Cocoa butter replacer |
| | based on fat I table 1 | based on fat II table 1 | based on fat III table 1 |
| Fat I | 88% | | |
| Fat II | | 88% | |
| Fat III | | | 88% |
| Interesterified mixture of: | 10% | 10% | 10% |
| (30% palm stearin IV 34 + | | | |
| 70% palm kernel stearin IV 7) | | | |
| Sorbitan tristearat* | 2% | 2% | 2% |
| Saturated fatty acids #4 | 69.3% | 68.0% | 65.4% |
| Monounsaturated fatty acids #4 | 25.9% | 27.3% | 29.6% |
| Poly unsaturated fatty acids #4 | 4.8% | 4.7% | 5.0% |

#4 IUPAC 2.304
*could be left out of the recipe

Fat IV to VI are analysed for crystallization time on a Mettler Toledo DSC 823e by using program Y, X, and Z as described below. The sample size is 10 mg+/−0.5 mg. Table 3 shows how much the three different CBR fat compositions are crystalized when using program Y, X, and Z, respectively. The heat of fusion from 20° C. to 50° C. is calculate in Joule/gram (J/g) and is used to express the crystalized fat after using different cooling times defined as “minutes below 21° C.”, see program Y, X, and Z.

### Program Y:

Isotherm 80° C. for 5 min, then

80° C.→46° C. at 10° C./min, then

46° C.→12° C. at 3° C./min, then

12° C.→50° C. at 3° C./min

### Program X:

Isotherm 80° C. 5 min, then

80° C.→46° C. at 10° C./min, then

46° C.→12° C. at 3° C./min, then

Isotherm 12° C. for 10 min, then

12° C.→50° C. at 3° C./min

### Program Z:

Isotherm 80° C. for 5 min, then

80° C.→46° C. at 10° C./min, then

46° C.→12° C. at 3° C./min, then

Isotherm 12° C. for 30 min, then

12° C.→50° C. at 3° C./min

TABLE 3

| DSC | | Fat composition | | |
|---|---|---|---|---|
| | Cooling time | IV Reference | V | VI |
| | defined as | Heat of fusion | Heat of fusion | Heat of fusion |
| | minutes | 20° C. → | 20° C. → | 20° C. → |
| | below | 50° C. | 50° C. | 50° C. |
| Program | 21° C. | J/g | J/g | J/g |
| Y | 6 min | 22.70 | 54.84 | 26.57 |
| X | 16 min | 40.61 | 73.76 | 63.45 |
| Z | 36 min | 70.24 | 78.09 | 71.73 |

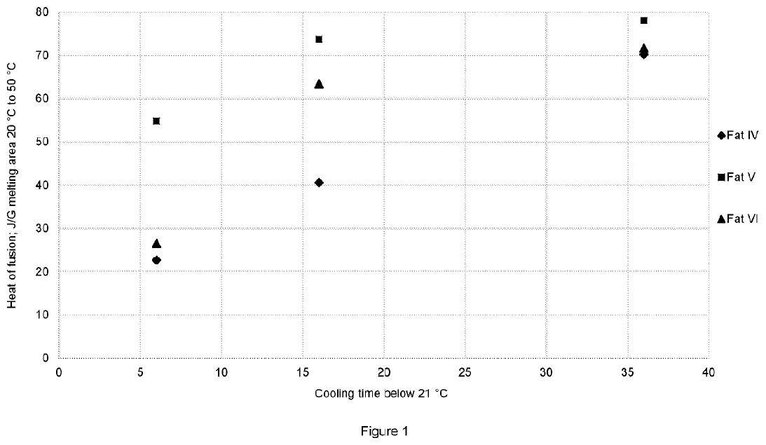

FIG. 1 shows the heat of fusion from table 3 as function of cooling time below 21° C. for the three different CBR fat compositions; fat composition IV, V, and VI (table 2).

Both fat composition V and VI crystallize significantly faster than the reference fat composition IV, i.e. fat composition V and VI has a higher heat of fusion at a certain given cooling time. The higher heat of fusion value indicate that more crystallization has taken place during the specific cooling time.

Table 3 and FIG. 1 shows very clearly a significant difference in crystallization speed for the three cocoa butter replacers IV, V, and VI. The crystallization speed is improved significantly in the interesterified fat compositions which have been esterified with fatty acids leading to a reduction in AG and an accompanying increase in TAG (Fat V and VI), compared with the reference fat composition (IV) which has a higher DAG content and a lower TAG content (see table 3 and FIG. 1).

### Example 3—Esterification of an Interesterified Oil Composition with Lauric Acid or with Oleic Acid, Palmitic Acid, and Stearic Acid

Esterification of an Interesterified Oil Composition with Lauric Acid

1 kg interesterified fat (MF oil blend, 1.18 mol based on an average triglyceride molar mass of 850 g/mol) and 176 g lauric fatty acids (0.88 mol) were mixed in a reaction vessel equipped with a vacuum inlet, a cold trap, and a condenser heated to 70° C. The reaction mixture was heated to 150° C. over app. 20 minutes under reduced pressure of 200 mbar. The temperature was gradually raised to 210° C. while the pressure was gradually lowered to 33 mbar over a 30 to 60 minutes period. Once the final reaction temperature was reached, the reaction mixture was left at these conditions for app. 10 hours. The crude oil obtained was distilled at 240° C. under reduced pressure to remove excess free fatty acids before being bleached and deodorized to yield the final product.

Esterification of an Interesterified Oil Composition with Oleic Acid, Palmitic Acid, and Stearic Acid

1 kg interesterified fat (MF oil blend, 1.18 mol based on an average triglyceride molar mass of 850 g/mol), 134 g palmitic acid (0.52 mol), 24 g stearic acid (0.08 mol), and 80 g oleic acid (0.29 mol) were mixed in a reaction vessel equipped with a vacuum inlet, a cold trap, and a condenser heated to 70° C. The reaction mixture was heated to 150° C. over app. 20 min under reduced pressure of mbar. The temperature was gradually raised to 210° C. while the pressure was gradually lowered to 33 mbar over a 30 to 60 minutes period. Once the final reaction temperature was reached, the reaction mixture was left at these conditions for app. 10 hours. The crude oil obtained was distilled at 240° C. under reduced pressure to remove excess free fatty acids before being bleached and deodorized to yield the final product.

Table 4 shows three vegetable fat compositions:
VII. Is a chemical interesterified fractionated fat composition which is bleached and deodorized. This is the reference fat composition with a relatively high DAG content, corresponding to an average amount present in an interesterified fat composition.
VIII. Is fat composition VII esterified with lauric acid to reduce the DAG content.
IX. Is fat composition VII esterified with a mixture of palmitic acid, stearic acid, and oleic acid to reduce the DAG content.

TABLE 4

| | Fat composition | | |
|---|---|---|---|
| | VII Reference | VIII Fat | IX Fat |
| | Bleached, | composition | composition VII |
| | deodorized, | VII esterified | esterified with |
| | interesterified | with lauric | palmitic acid, stearic |
| | fat composition | acid | acid. and oleic acid |
| TAG < C 40 #1 | <0.1 | <0.1 | <0.1 |
| TAG C 40 #1 | <0.1 | <0.1 | 0.1 |
| TAG C 42 #1 | <0.1 | 1.1 | 0.1 |
| TAG C 44 #1 | <0.1 | 6.0 | 0.3 |
| TAG C 46 #1 | 1.2 | 10.2 | 1.1 |
| TAG C 48 #1 | 10.2 | 11.6 | 13.2 |
| TAG C 50 #1 | 54.0 | 40.9 | 50.2 |
| TAG C 52 #1 | 28.1 | 21.9 | 28.4 |
| TAG C 54 #1 | 6.1 | 4.8 | 6.0 |
| TAG C 56 #1 | 0.4 | 0.4 | 0.4 |
| TAG C 58 #1 | <0.1 | 0.1 | 0.1 |
| TAG > C 58 #1 | <0.1 | <0.1 | <0.1 |
| Mono-glyceride #2 | <0.1 | <0.1 | <0.1 |
| Di-glycerides #2 | 11.4 | 2.0 | 1.6 |
| Tri glycerides #2 | 86.4 | 95.8 | 93.7 |
| Solid fat content | 79.5 | 82.5 | 80.4 |
| 20° C. #3 | | | |
| Solid fat content | 63.7 | 58.3 | 64.0 |
| 25° C. #3 | | | |
| Solid fat content | 34.6 | 36.8 | 43.7 |
| 30° C. #3 | | | |
| Solid fat content | 17.9 | 17.6 | 26.7 |
| 35° C. #3 | | | |
| C12:0 lauric | 0.1 | 6.3 | 0.1 |
| acid #4 | | | |

#1 IUPAC 2.323
#2 AOCS Cd 22-91
#3 IUPAC 2.150a (serial)
#4 IUPAC 2.304

The different solid fat content in Table 4 shows how it is possible to get different melting properties depending on the chosen fatty acids used. Using lauric acid as in fat VIII produces a solid fat content more identical to the reference fat than using a mixture of palmitic acid, stearic acid, and oleic acid as in fat IX.

### Example 4—Fat Mixtures of Fat Composition VII, VIII, and IX and an Interesterified Mixture of 30% Palm Stearin IV 34+70% Palm Kernel Stearin IV 7

Fat composition VII, VIII, and IX are used as the major component (88%) in three fat compositions shown in table 5. Fat composition X, XI, and XII are fat compositions which can be use as cocoa butter replacers (CBRs) in chocolate like compounds for coating and moulding applications as well as for very hard filling applications.

TABLE 5

| | Fat composition | | |
|---|---|---|---|
| | X Reference | XI | XII |
| | Cocoa butter replacer | Cocoa butter replacer | Cocoa butter replacer |
| | based on fat VII table 4 | based on fat VIII table 4 | based on fat IX table 4 |
| Fat VII | 88% | | |
| Fat VIII | | 88% | |
| Fat IX | | | 88% |
| Interesterified mixture of: | 10% | 10% | 10% |
| (30% palm stearin IV 34 + | | | |
| 70% palm kernel stearin IV 7) | | | |
| Sorbitan tristearat* | 2% | 2% | 2% |
| Saturated fatty acids #4 | 69.3 | 72.2 | 70.8 |
| Monounsaturated fatty acids #4 | 25.9 | 23.8 | 25.3 |
| Poly unsaturated fatty acids #4 | 4.8 | 4.0 | 3.9 |

#4 IUPAC 2.304
*could be left out of the recipe.

Fat X, XI, and XII are analysed for crystallization time on a Mettler Toledo DSC 823e by using program Y, X, and Z as described below. Sample size is 10 mg+/−0.5 mg. Table 6 shows how much the three different CBR fat compositions are crystalized when using program Y, X, and Z, respectively. The heat of fusion from 20° C. to 50° C. is calculate as Joule/gram (J/g) and is used to express the crystalized fat after using different cooling times defined as minutes below 21° C., see program Y, X, and Z.

### Program Y:

Isotherm 80° C. for 5 min, then

80° C.→46° C. at 10° C./min, then

46° C.→12° C. at 3° C./min, then

12° C.→50° C. at 3° C./min

### Program X:

Isotherm 80° C. 5 min, then

80° C.→46° C. at 10° C./min, then

46° C.→12° C. at 3° C./min, then

Isotherm 12° C. for 10 min, then

12° C.→50° C. at 3° C./min

### Program Z:

Isotherm 80° C. for 5 min, then

80° C.→46° C. at 10° C./min, then

46° C.→12° C. at 3° C./min, then

Isotherm 12° C. for 30 min, then

12° C.→50° C. at 3° C./min

TABLE 6

| DSC | | Fat composition | | |
|---|---|---|---|---|
| | Cooling time | X Reference | XI | XII |
| | defined as | Heat of fusion | Heat of fusion | Heat of fusion |
| | minutes | 20° C. → | 20° C. → | 20° C. → |
| DSC | below | 50° C. | 50° C. | 50° C. |
| program | 21° C. | J/g | J/g | J/g |
| Y | 6 min | 22.70 | 62.5 | 41.6 |
| X | 16 min | 40.1 | 76.8 | 62.5 |
| Z | 36 min | 70.4 | 81.5 | 74.0 |

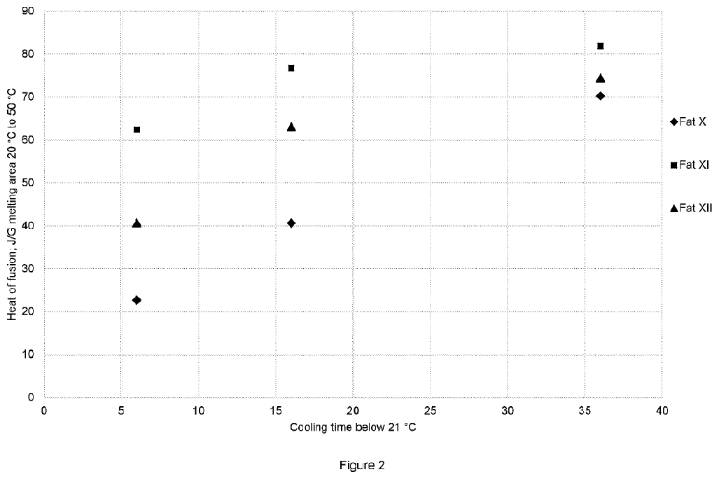

FIG. 2 shows the heat of fusion from table 6 as function of cooling time below 21° C. for the 3 different CBR fat compositions (table 5). Both fat composition XI and XII crystallize significantly faster compared to the reference fat composition, X, i.e. fat composition XI and XII has a higher heat of fusion at a certain given cooling time. The higher heat of fusion value indicate that more crystallization has taken place during the specific cooling time.

Table 6 and FIG. 2 shows a significant faster crystallization for fat composition XI and XII compared the reference fat, X. The reduction in DAG and increase in TAG of Fat XI and XII compared to the reference is the reason for the improvement of crystallization speed.

### Example 5—Recipes and Manufacture of Chocolate-Like Coatings

Three chocolate like coating are produced using fat IV, V, and VI from table 2. Table 7 displays the recipes used in this example.

TABLE 7

| | Recipe for compound | | |
|---|---|---|---|
| | (amounts in %) | | |
| | A | B | C |
| Sugar | 43.58 | 43.58 | 43.58 |
| Fat IV | 35.00 | 0.00 | 0.00 |
| Fat V | 0.00 | 35.00 | 0.00 |
| Fat VI | 0.00 | 0.00 | 35.00 |
| Cocoa powder (10-12% | 15.00 | 15.00 | 15.00 |
| fat)—Alkalized | | | |
| Skim milk powder | 6.00 | 6.00 | 6.00 |
| Lecithin | 0.40 | 0.40 | 0.40 |
| Vanillin | 0.02 | 0.02 | 0.02 |
| Total fat content | 36.0 | 36.70 | 36.70 |

All ingredients, except a part of the fat and lecithin, are mixed in a Teddy Mixer with heat jacket to a texture like marzipan at 50° C. The three mixtures are each refined afterwards on a three rolls Buhler refiner to an average particle size at 20 microns. The refined mass is chonched together with the remaining fat for 6 hours at 50° C. on a Teddy mixer (AR005). A half hour before the chonching process is finished, lecithin and the remaining fat is added.

The final compounds A, B, and C is mixed in a Teddy mixer at 45° C. for 30 minutes to ensure a total homogeneous compound at 45° C. before enrobing test is made on a Nielsen enrober. The Nielsen baby flex enrober 95-22 is kept at the same settings (speed and air cooling) for all three trials.

The enrobed sponge cakes are cooled directly in a three zone Morcos cooling tunnel (SL-305-6) with an air temperature at 15° C., 12° C., and 15° C., respectively, and an air velocity at 1.5 m/s. The test is done for five different cooling times to calculate the optimal cooling time for the three compounds individually.

The score scale is as follows:
1. Still liquid coating on some parts of the biscuit, while other parts are semi solidified.
2. The whole coating is semi solidified, but very sticky and very soft. No liquid coating area.
3. The whole coating has solidified, still sticky, soft, and not ready for packaging.
4. The whole coating is hard and none-sticky. It is possibly to pack the product.
5. 100% solidification. Further cooling do not change anything.

Table 8 shows the results from this cooling test.

TABLE 8

| | Compound | | |
|---|---|---|---|
| | A | B | C |
| 5 minutes in a | 2 | 3 | 2 |
| 15-12-15° C. tunnel | | | |
| 6 minutes in a | 3 | 3 | 3 |
| 15-12-15° C. tunnel | | | |
| 7 minutes in a | 3 | 4 | 4 |
| 15-12-15° C. tunnel | | | |
| 8 minutes in a | 4 | 5 | 4 |
| 15-12-15° C. tunnel | | | |
| 9 minutes in a | 4 | 5 | 5 |
| 15-12-15° C. tunnel | | | |

Table 8 shows that the crystallization speed is also improved when using fat V and VI in a coating recipe compared using the reference fat IV. Especially the coating B based on fat V shows a big improvement in crystallization time. This gives the benefit of increasing the capacity on the chocolate production line with approximately 20-25%.

The invention is further described in the following non-limiting items.
1. An interesterified triglyceride composition with an amount of diglycerides (DAG) of no more than 5% by weight, such as no more than 4% by weight, such as no more than 3% by weight, such as no more than 2% by weight, such as no more than 1% by weight, such as no more than 0.5% by weight or such as no more than 0.2% by weight.
2. The interesterified triglyceride composition according to item 1, wherein the amount of DAG is in the range of 0.2% to 5% by weight, such as in the range of 0.5% to 4% by weight, such as in the range of 0.5% to 3% by weight, such as in the range of 0.5% to 2% by weight.
3. The interesterified triglyceride composition according to any of the preceding items, wherein the interesterified triglyceride composition is a vegetable interesterified triglyceride composition.
4. The interesterified triglyceride composition according to any of the preceding items, wherein the interesterified triglyceride composition is a chemically interesterified triglyceride composition.
5. The interesterified triglyceride composition according to any of items 1 to 3, wherein the interesterified triglyceride composition is an enzymatically interesterified triglyceride composition.
6. The interesterified triglyceride composition according to any of the preceding items, wherein the sum of saturated C8, C10, C12, and C14 fatty acids is at least 0.75% by weight, such as at least 1% by weight, such as at least 1.25% by weight, or such as at least 1.5% by weight.
7. The interesterified triglyceride composition according to any of the preceding items, wherein the sum of saturated C8, C10, C12 and C14 fatty acids is in the range of 0.75% to 20% by weight, such as in the range of 1% to 15% by weight, such as in the range of 1% to 10% by weight, or such as in the range of 1% to 7.5% by weight.
8. The interesterified triglyceride composition according to any of the preceding items, wherein the sum of saturated C12 and C14 fatty acids is at least 0.75% by weight, such as at least 1% by weight, such as at least 1.25% by weight, or such as at least 1.5% by weight.
9. The interesterified triglyceride composition according to any of the preceding items, wherein the sum of saturated C12 and C14 fatty acids is in the range of 0.75% to 20% by weight, such as in the range of 1% to 15% by weight, such as in the range of 1% to 10% by weight, or such as in the range of 1% to 7.5% by weight.
10. The interesterified triglyceride composition according to any of the preceding items, wherein the amount of myristic acid (C14:0) is at least 0.75% by weight, such as at least 1% by weight, such as at least 1.25% by weight, or such as at least 1.5% by weight.
11. The interesterified triglyceride composition according to any of the preceding items, wherein the amount of myristic acid is in the range of 0.75% to 20% by weight, such as in the range of 1% to 15% by weight, such as in the range of 1% to 10% by weight, or such as in the range of 1% to 7.5% by weight.
12. The interesterified triglyceride composition according to any of the preceding items, wherein the amount of lauric acid (C12:0) is in the range of 0% to 5% by weight, such as in the range of 0.75% to 5% by weight, such as in the range of 1% to 5% by weight, or such as in the range of 1% to 4% by weight.
13. The interesterified triglyceride composition according to any of the preceding items, wherein:
   the amount of DAG is no more than 3.0% by weight; and
   the sum of saturated C8, C10, C12 and C14 fatty acids is at least 0.75% by weight, such as at least 1% by weight, such as at least 1.25% by weight, or such as at least 1.5% by weight.
14. The interesterified triglyceride composition according to any of the preceding items, wherein:
   the amount of DAG is no more than 2.6% by weight; and
   the sum of saturated C8, C10, C12 and C14 fatty acids is at least 0.75% by weight, such as at least 1% by weight, such as at least 1.25% by weight, or such as at least 1.5% by weight.
15. The interesterified triglyceride composition according to any of the preceding items, wherein:
   the amount of DAG is no more than 2.4% by weight; and
   the sum of saturated C8, C10, C12 and C14 fatty acids is at least 0.75% by weight, such as at least 1% by weight, such as at least 1.25% by weight, or such as at least 1.5% by weight.
16. The interesterified triglyceride composition according to any of items 1 to 12, wherein:
   the amount of DAG is no more than 3.0% by weight; and
   the amount of myristic acid is at least 0.75% by weight, such as at least 1% by weight, such as at least 1.25% by weight, or such as at least 1.5% by weight.
17. The interesterified triglyceride composition according to any of items 1 to 12, wherein:
   the amount of DAG is no more than 2.6% by weight; and
   the amount of myristic acid is at least 0.75% by weight, such as at least 1% by weight, such as at least 1.25% by weight, or such as at least 1.5% by weight.
18. The interesterified triglyceride composition according to any of items 1 to 12, wherein:
   the amount of DAG is no more than 2.4% by weight; and
   the amount of myristic acid is at least 0.75% by weight, such as at least 1% by weight, such as at least 1.25% by weight, or such as at least 1.5% by weight.
19. An oil mixture comprising an interesterified triglyceride composition according to any of the preceding items in an amount of 50% to 99.5% by weight, such as 60% to 95% by weight, such as 70% to 95% by weight, such as 80% to 95% by weight, or such as 85% to 90% by weight and at least one vegetable oil component.
20. The oil mixture according to item 19 wherein the at least one vegetable oil component is selected from the group consisting of palm kernel oil, coconut oil, shea oil, high lauric rapeseed oil and/or fractions thereof or an interesterified, fractionated, and/or hydrogenated version of palm kernel oil, coconut oil, shea oil, high lauric rapeseed oil, and/or fractions thereof.
21. The oil mixture according to item 19 or 20 wherein the at least one vegetable oil component is selected from the group consisting of palm stearin, palm kernel stearin, coconut oil, shea oil, and/or fractions thereof or an interesterified, fractionated, and/or hydrogenated version of palm stearin, palm kernel stearin, coconut oil, shea oil, and/or fractions thereof.
22. Use of the interesterified triglyceride composition according to any of items 1 to 18 or the oil mixture according to any of items 19 or 21 in coating or enrobing for bakery, confectionery, and/or moulding applications, or in fillings, such as bakery fillings and confectionery fillings or for chocolate and chocolate-like coatings.
23. An edible product comprising the interesterified triglyceride composition according to any of items 1 to 18 or the oil mixture according to any of items 19 or 21.
24. A method for production of an interesterified triglyceride composition according to any of items 1 to 18, wherein the method comprises the steps of:
   a) providing an interesterified oil composition and mixing said interesterified oil composition with a fatty acid mixture in a reaction container hereby obtaining an interesterified oil and fatty acid mixture blend;
   b) heating the interesterified oil and fatty acid mixture blend under reduced pressure over a predefined period of time;
   c) further increasing the temperature and heating the interesterified oil and fatty acid mixture blend over a predefined period of time, and simultaneously lowering the pressure further compared to step b);
   d) keeping the interesterified oil and fatty acid mixture blend at the temperature and pressure of step c) for a predefined period of time;
   e) optionally, removal of unreacted residue reactants from the resulting product of step d) by a distillation process;
   f) optionally, bleaching, filtering, and/or deodorization of the resulting product of step d) or step e);
   thereby obtaining said interesterified triglyceride composition.
25. The method according to item 24, wherein the steps a) to f) are sequentially in that order.
26. The method according to any of item 24 or 25, wherein step b) and step c) are combined into one step by continuously heating the interesterified oil and fatty acid mixture blend to the wanted temperature under reduced pressure over a predefined time.
27. The method according to any of item 24 or 25, wherein step c) comprises two steps; c1) lowering the pressure compared to step b) over a predefined period of time; c2) increasing the temperature under the reduced pressure of step c1) over a predefined period of time.
28. The method according to item 27 wherein step c1) and step c2) are sequentially in that order.
29. The method according to item 27 wherein step c1) and step c2) are reversed.
30. The method according to any of items 24 to 29, wherein the interesterified oil composition comprises lauric acid (C12:0) in amounts of no more than 1% by weight, such as no more than 0.5% by weight, such as no more than 0.2% by weight, or such as no more than 0.1% by weight.
31. The method according to any of items 24 to 30, wherein the interesterified oil composition comprises myristic acid (C14:0) in amounts of no more than 20% by weight, such as no more than 15% by weight, such as no more than 10% by weight, or such as no more than 5% by weight.

1. An interesterified triglyceride composition comprising an amount of diglycerides (DAG) of no more than 5% by weight.

2. The interesterified triglyceride composition according to claim 1, wherein the amount of DAG is in the range of 0.2% to 5% by weight.

3. The interesterified triglyceride composition according to claim 1, wherein the interesterified triglyceride composition is a vegetable interesterified triglyceride composition.

4. The interesterified triglyceride composition according to claim 1, wherein the interesterified triglyceride composition is a chemically interesterified triglyceride composition or an enzymatically interesterified triglyceride composition.

5. The interesterified triglyceride composition according to claim 1, wherein the sum of saturated C8, C10, C12, and C14 fatty acids is at least 0.75% by weight.

6. The interesterified triglyceride composition according to claim 1, wherein the sum of saturated C12 and C14 fatty acids is at least 0.75% by weight.

7. The interesterified triglyceride composition according to claim 1, wherein the amount of myristic acid (C14:0) is at least 0.75% by weight.

8. The interesterified triglyceride composition according to claim 1, wherein the amount of lauric acid (C12:0) is in the range of 0% to 5% by weight.

9. An oil mixture comprising an interesterified triglyceride composition according to claim 1 in an amount of 50% to 99.5% by weight and at least one vegetable oil component.

10. The oil mixture according to claim 91 wherein the at least one vegetable oil component is selected from the group consisting of palm kernel oil, coconut oil, shea oil, high lauric rapeseed oil and/or fractions thereof or an interesterified, fractionated, and/or hydrogenated version of palm kernel oil, coconut oil, shea oil, high lauric rapeseed oil, and/or fractions thereof.

11. The interesterified triglyceride composition according to claim 1, wherein the interesterified triglyceride composition is used in coating or enrobing for bakery, confectionery, and/or moulding applications, or in fillings, or for chocolate and chocolate-like coatings.

12. An edible product comprising the interesterified triglyceride composition according to claim 1.

13. A method for production of an interesterified triglyceride composition according to claim 1, wherein the method comprises the steps of:
a) providing an interesterified oil composition and mixing said interesterified oil composition with a fatty acid mixture in a reaction container to obtain an interesterified oil and fatty acid mixture blend;
b) heating the interesterified oil and fatty acid mixture blend under reduced pressure over a predefined period of time;
c) further increasing the temperature and heating the interesterified oil and fatty acid mixture blend over a predefined period of time, and simultaneously lowering the pressure further compared to step b); and
d) keeping the interesterified oil and fatty acid mixture blend at the temperature and pressure of step c) for a predefined period of time;
to obtain said interesterified triglyceride composition.

14. The oil mixture according to claim 9, wherein the oil mixture is used in coating or enrobing for bakery, confectionery, and/or moulding applications, or in fillings, or for chocolate and chocolate-like coatings.

15. An edible product comprising the oil mixture according to claim 9.

16. The method according to claim 13, further comprising:
e) removing unreacted residue reactants from the resulting product of step d) by a distillation process.

17. The method according to claim 16, further comprising:
f) bleaching, filtering, and/or deodorization of the resulting product of step d) or step e).
